(19) United States
(12) Patent Application Publication
(10) Pub. No.: US 2005/0255298 A1
(43) Pub. Date: Nov. 17, 2005

(54) Linerless label with starch based release coating and method of creating

(76) Inventor: Jesse D. Crum, Fort Scott, KS (US)

Correspondence Address: WARD KRAFT, INC., P.O. BOX 938, FORT SCOTT, KS, 66701, US

(21) Appl. No.: 10/846,745

(22) Filed: May 14, 2004

(51) Int. Cl. B32B 9/00

(52) U.S. Cl. 428/195.1

(57) ABSTRACT

The present invention is directed to a linerless label that utilizes a starch or starch ester based coating as a release coating. The release coating of the linerless label can be used to provide textural or aesthetic characteristics to the label in various patterns or arrangements as may be selected by the end user or manufacturer of the product.

### CROSS-REFERENCES TO RELATED APPLICATIONS

None.

### FIELD OF THE INVENTION

The present invention is directed to the field of pressure sensitive products, more particularly to pressure sensitive products, such as labels that are provided without a separate web of release liner material that must be peeled away or removed prior to the adhesive being exposed. The subject of the instant specification is directed to pressure sensitive products known generally as linerless labels, labels in which no liner web is provided.

### BACKGROUND OF THE INVENTION

Linerless labels are generally known and typically include a substrate having a pressure sensitive adhesive coated or applied to one side and on the other side or opposite side a silicone release agent is coated or applied. Some prior art examples of linerless labels include U.S. Pat. Nos. 5,292,713, 5,336,541, 5,354,588, 5,547,738, 5,651,852 and 5,782,496.

Linerless labels have been generally promoted as being environmentally friendly in that there is no release liner to dispose of or discard, thus filling up valuable landfill space. In addition, such linerless labels have also been promoted as being more efficient for handling purposes in that twice as many labels can be delivered in a single roll of material as opposed to conventional labels as there is no release liner to take up space in the roll configuration.

Linerless labels have also been touted as reducing the amount of handling equipment that is necessary to utilize such linerless labels in that the manufacturer no longer requires a rewind or take up roll to handle the release liner as it is peeled away from the pressure sensitive label material prior to application of the label to the substrate. Moreover, it has been suggested that elimination of the liner material from the work place may reduce accidents as the removed liner if left on a production floor can cause a worker to slip and fall due to the slick coating of the release liner material.

Despite the foregoing enumerated benefits for using linerless labels, these products simply have not been generally accepted for use in industry or other commercial or consumer applications. While many acknowledge the benefit of such labels, unfortunately the cost of linerless labels is usually slightly higher than conventional linered labels of similar size and as such and despite the benefits of linerless labels, conversion to a linerless format has generally not occurred.

Various release coatings have been developed but those that are generally commercially available include silicone and waxed based coatings. U.S. Pat. No. 5,945,468 describes the use of a starch ester based coating for use as a release material in connection with pressure sensitive products. The coating is applied to a label stock material (liner) and then was tested for release strength as an adhesive article (tape) was then applied to the coating and removed. However, such a solution still suggests the use of a release liner in combination with a pressure sensitive label, in a linered format or laminated structure.

Publications, patents and patent applications are referred to throughout this disclosure. All references cited herein are hereby incorporated by reference.

What is needed therefore is a linerless label product that retains the environmental and other desirable benefits provided by previous linerless label applications but which can be provided at a reduced cost, without adversely affecting performance such that linerless labels may then be adapted and widely used.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention pertains to linerless labels that utilize a starch, starch ester or combinations thereof to provide a release coating such that when the labels are wound onto themselves such as in a continuous format or a roll, the labels may be easily unwound without tearing or removal of the adhesive from the face of the substrate onto which it has been coated. In addition the coating of the present invention can be used to provide a discontinuous surface, such that the adhesive cannot completely bond with release coated face due to the discontinuous surface conditions, in that the surface appears “grainy”.

The coating of the present invention also surprisingly creates a frangible or fracturable surface on the label such that by bending and cracking portions of the label can be easily removed or separated from the linerless label so as to create additional identification or decorative items.

In one exemplary embodiment, a linerless label is described and includes a substrate which has first and second side edges and first and second ends and first and second faces. On one side of the substrate a pressure sensitive adhesive is applied in a pattern to at least a portion of the first face and on the other side of the substrate a starch or starch ester based release coating is applied in a pattern to at least a portion of the second face.

In a still further embodiment of the present invention, a linerless label, is described and includes a substrate that has first and second sides, first and second ends and top and bottom faces. A pressure sensitive adhesive is applied to the first side of the substrate and a release coating which has a starch or starch ester based component is applied to the second side of the substrate. The release coating is applied in such a manner so that it is provided in first and second patterns with the first pattern of the release coating being applied substantially entirely over the second face and the second pattern of release coating being applied only to predetermined portions of the second face to create texturally distinct areas.

In a yet still further embodiment of the present invention, a method of producing a linerless label is described and includes the steps of initially advancing a substrate having first and second faces. The substrate may be provided in a continuous or in a cut sheet format depending upon the particular application. Next, the first face of the substrate is coated with a pattern of pressure sensitive adhesive. Then at least a first pattern of release coating which contains starch, a starch ester or combinations thereof is applied to the second face of substrate such that the pattern of release coating is at least equal to the pattern of pressure sensitive adhesive.

In other embodiment of the foregoing method, a second pattern of release is applied and the second pattern is texturally distinct from the first pattern. The second coating can be applied after the first coating or the coatings can be applied substantially simultaneously.

A further embodiment of the present invention relates to a linerless label, that includes a substrate which has top and bottom faces. A pattern of adhesive is applied to the bottom face of the substrate and a discontinuous release coating is applied to the top surface of the substrate. The amount or area of the release coating is at least equal to an area covered by the pattern of adhesive. The discontinuous coating that provides the irregular surface contains a starch, starch ester component or a combination thereof.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of the linerless label of the present invention;

FIG. 2 shows first and second release coatings as used in the present invention with the second coating being utilized to depict a textural or aesthetic characteristic;

FIG. 3 provides a series of linerless labels connected in a continuous or roll format;

FIG. 4 illustrates the discontinuous surface configuration created through the use of the starch, starch ester or combinations thereof in the creation of the release coating for the present invention;

FIG. 5 shows an alternative embodiment of the present invention in which detachable portions can be formed in the linerless label due to the coating that has been applied;

FIG. 5A illustrates the frangible nature of the coating applied to the linerless label and the separation of the detachable portions shown in FIG. 5;

FIG. 6 depicts a schematic diagram showing an exemplary method in the preparation of the linerless labels of the present invention; and

FIG. 7 provides a block diagram showing an exemplary method of carrying out the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been found that through the use of starches, starch esters or combinations thereof such as those derived from corn, rice, wheat, potato, tapioca, maize, sorghum and other starches and starch flours and combinations thereof, that effective release coatings can be created for linerless labels. In addition, through the use of the starch component as described herein, it has also been found that irregular or grainy surfaces can be prepared, such as discontinuous surfaces that create a textural characteristic or roughened surface which aids in adhesive releasing from the surface.

In addition, this discovery has lead to the unexpected finding that the use of such starch based elements in these coatings can allow for the creation of textural or aesthetic features in business communication thus enabling the manufacturer to readily and easily pass along to the end user or customer various additional attributes which were heretofore unavailable. That is, patterns can be applied to the release coated side of the label so as to illustrate or highlight a feature of the label, such as a logo, trade name, trademark, pictorial representation, other graphic, indicia, shape, pattern or the like.

The term “discontinuous” as used herein refers to a surface that is irregular, grainy or that has numerous peaks and valleys, or interruptions or repeated breaks in the plane of the surface.

The coating of the present invention may be used in any number of applications depending on the needs of the end user or the catalog or product offering of the manufacturer to create products other than pressure sensitive products such as business forms, information handling materials business communication pieces, coupons, cards, tickets, greeting cards, brochures, folders, tickets, cards, photographs, marketing collateral, presentation materials and combinations thereof.

Corn starch, is widely available from any consumer retail or wholesale outlet such as grocery stores (e.g. Safeway, Giant, Kroger, Dillions, Wal-Mart, Target, Sam's Club, etc.). The corn starch is added along with water or other materials such as inks or pigments in the event color for the release coating is needed in an amount ranging from 0.01% to 99.9% by weight, with about 2 to about 50% being preferred and about 6 to about 45% being still more preferred. The corn starch is mixed to form an aqueous slurry or paste like substance.

In addition to corn starch, the invention may also be used with potato, rice, wheat, tapioca, maize, sorghum and other starches and starch flours and combinations thereof. Starches may also be purchased in bulk from National Starch and Chemical Company, Chicago, Ill. In addition, starch esters may also be used having between 2 and 100 carbon atoms. Exemplary starch esters include, but are not limited to starch acetate, starch butyrate, starch hexanote, starch benzoate, starch propionate and combinations of the foregoing.

The invention may also use high amylose starch (starch having at least 45% and likely more than 65% amylose content) or low amylose starch (starch having less than 45% amylose content and preferably less than 35%).

The aqueous slurry or paste can then be applied through the use of anilox rollers directly to the substrate without any further modification or treatment. The substrate may be subjected to drying in the event the moisture content of the slurry is too high and changes the content of the substrate. By being able to utilize an economical component and apply the coating in an efficient manner without the necessity of additives or other supplements, linerless labels can be produced relatively economically.

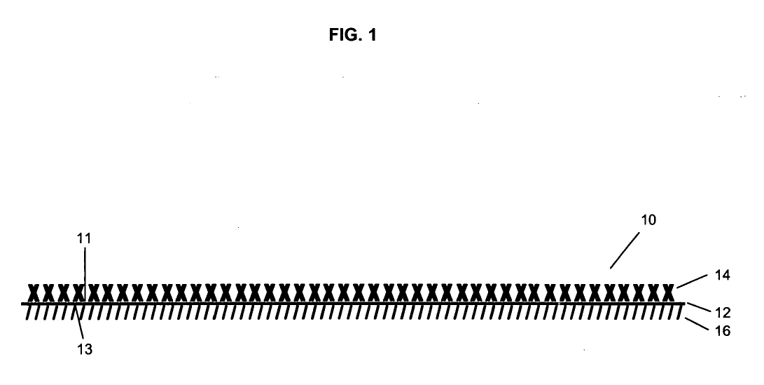

Turning now to FIG. 1 of the present invention, a linerless label is generally depicted by reference to numeral 10. The substrate 12 is typically a cellulosic material such as paper, bond or tag stock, but may also be metal or synthetic films such as plastic (polyethylene). The substrate 12 has first and second faces 11 and 13. On the first face 11, a pattern of pressure sensitive adhesive 14 is applied. On the second face 13 of the substrate 12 a release coating 16, containing a starch component is applied.

The adhesive and release coatings may be applied in patterns or may be applied over the entire surface of the respective faces to which they are applied. The release material is preferably applied over an area that is at least equal to the area that is covered by the adhesive but it should be understood that more area covered by the release material could be provided such as to compliment a marketing theme or provide additional area for message delivery.

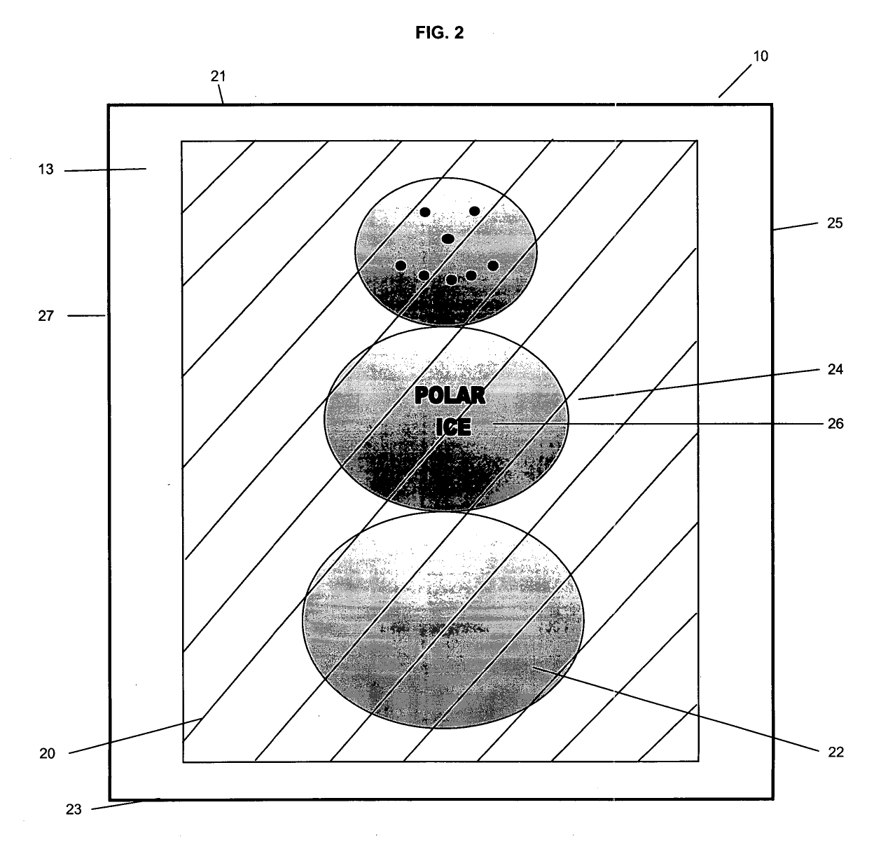

FIG. 2 provides a view of the release coated face 13 of the linerless label 10 of the present invention. In this embodiment, a first pattern of release 20 is applied in a first area of the second face 13 and a second pattern of release 22 is provided in a second area of the second face 13. For ease of application, the first release coating may be applied throughout the area to be covered with a release coating and then the second pattern of release coating applied over the top of the first pattern. Alternatively, the first pattern 20 could be applied in particular or specific areas of the face 13 and the second pattern 22 applied in select or predetermined areas.

As shown in FIG. 2, the second pattern 22 is used to provide a different textural characteristic than the first pattern. The characteristic will normally have both aesthetic and tactical characteristics making it readily discernable from the surrounding release area. As illustrated in the FIGURE a snowman 24 is presented to represent that any shapes may be created through use of the present coatings. In addition, FIG. 2 shows that indicia 26 can also be created in the release coating.

FIG. 2 also provides that the linerless label of the present invention has first and second sides 25 and 27 and first and second ends 21 and 23. Of course the linerless label of the present invention may be provided in any particular shape but generally quadrate is typical.

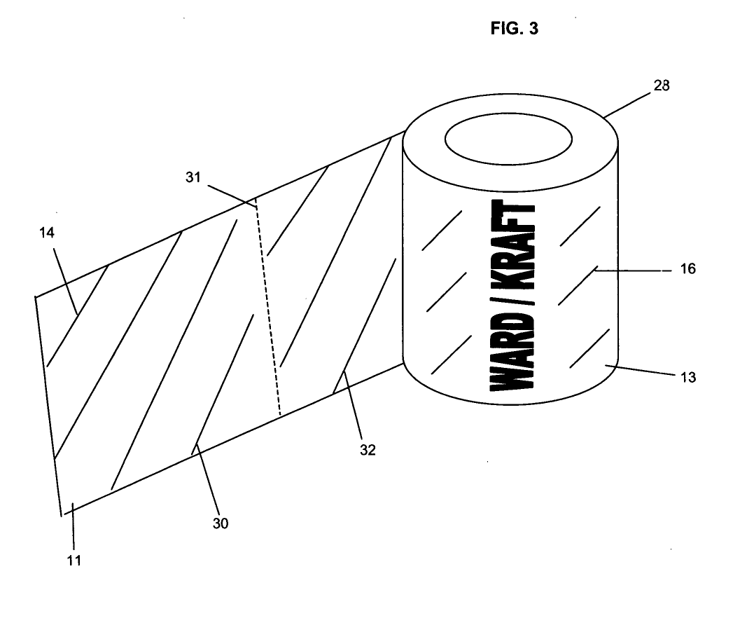

FIG. 3 shows the linerless labels of the present invention being provided in a continuous format such as a roll 28. Individual labels 30 and 32 are shown and are separable from one another through a line of weakness such as a line of perforation 31. Typically, the adhesive 14 coated face 11 will be wound internally of the roll 28 so that it contacts the release 16 coated face 13 of the roll of labels. In this way, the labels can be easily unwound from the roll of labels.

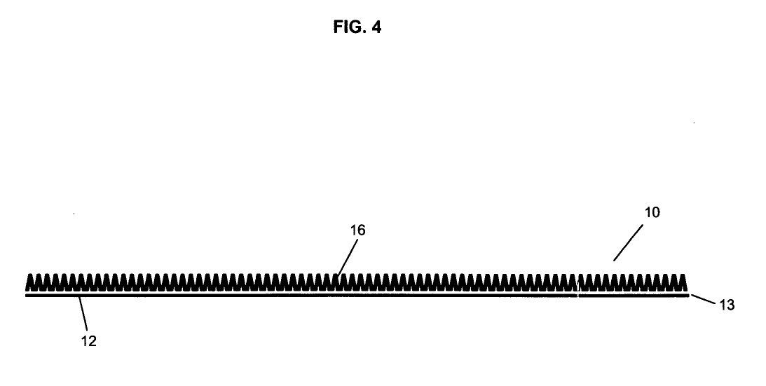

FIG. 4 presents a schematic of a magnified view of a cross section of the present invention. The linerless label 10 is shown with its substrate 12 on which second face 13 has been coated with the release coating of the present invention. As can be seen from the FIGURE, the surface is discontinuous in that it has a number of surface irregularities. These discontinuities and irregularities limit the contact of the adhesive with the surface or face of the substrate which thus permits the adhesive to release more readily from the substrate 10.

The discontinuities are created by the particles of the starch component such that the surface appears or looks “grainy” as if sand or other fine particulate was adhered to the surface of the sheet of substrate. The size of the particulate can be adjusted such as through fine milling of the starch or running the starch through smaller and smaller screens to sort out the larger particles and obtain the particular particulate size that is used in the present invention. Common food grade starch has been found to contain an adequate particulate size to carry out the invention.

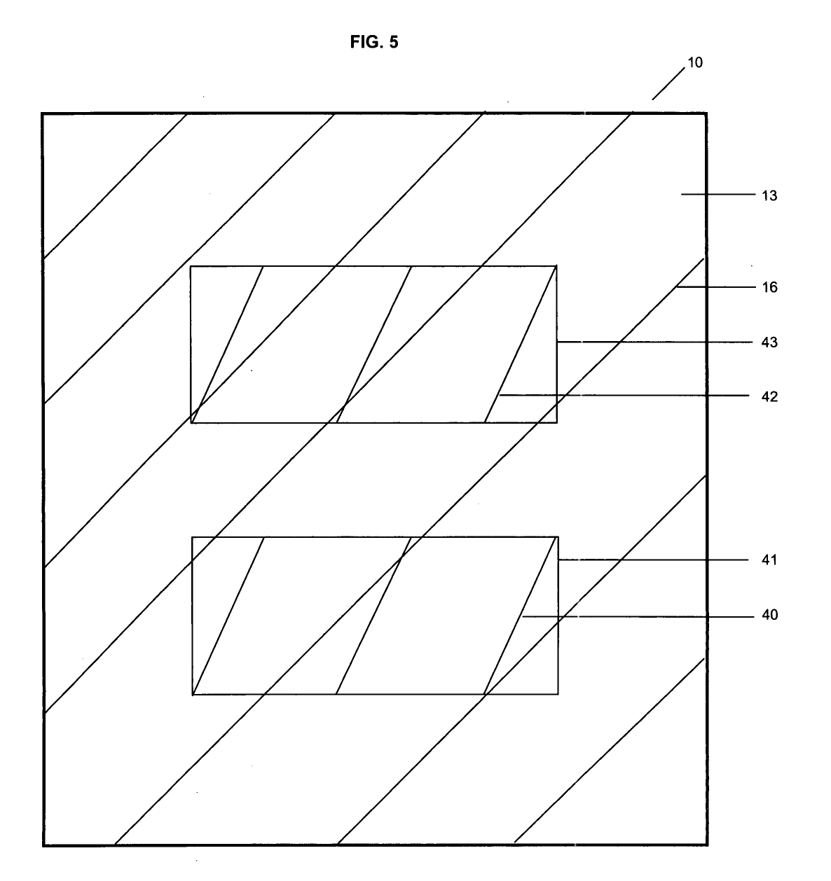

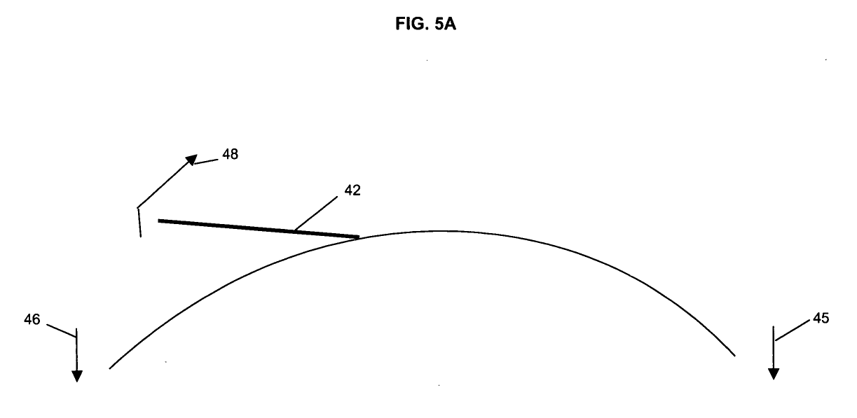

Reference is now directed to FIG. 5, which provides a linerless label 10 and face 13 having a release coating 16 provided thereon. The label 10 is provided with a pair of removable elements 40 and 42 which are separable from the remainder of the label 10 via lines of weakness 41 and 43. The release coating 16 creates a relatively rigid surface, but one that is flexible enough to be able to wound onto a roll, which can then be easily bent and flexed so as to cause one or more of the removable elements 40 and 42 to pop out of the label 10 as is shown in FIG. 5A.

FIG. 5A shows the forces 45 and 46 that are applied to the substrate 12 so that removable element 42 will pop up as shown by the directional arrow 48. In this way, one or more, smaller linerless adhesive elements can be created which would allow one the opportunity to tag or mark another product or surface for identification while still retaining the indicia of the larger label 10.

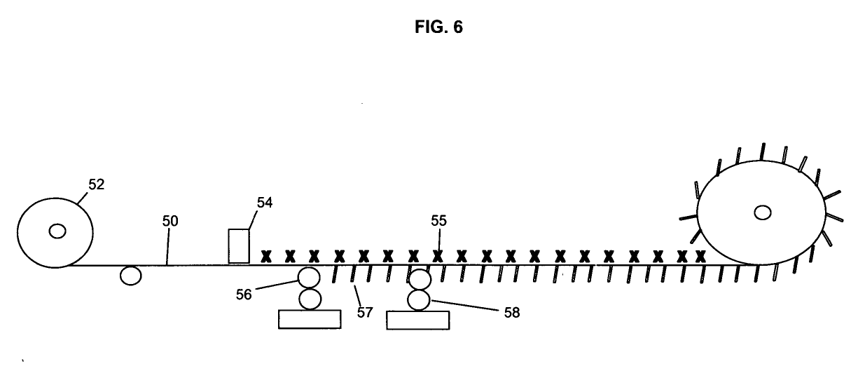

FIG. 6 shows a schematic of the process used in the manufacturing the linerless labels of the present invention. Initially, a substrate 50 is unwound from a supply 52. It should be understood that instead of a roll or continuous supply of product that the supply may constitute a stack of sheets so that the invention could be manufactured in a cut sheet arrangement.

The substrate 50 passes under an adhesive coating station such as a slot die coater where an adhesive is applied. The adhesive may be a permanent type adhesive, removable or repositionable. The adhesive 55 is applied to the substrate 50. Next, a first pattern of release containing 57 the starch is applied such as through an anilox system 56 in which a supply of the material is fed via rollers into contact with the substrate. A second release coating station 58 is also provided in FIG. 6. Finally, the web of material is rewound or otherwise collected.

A die station may be added so as to create the removable elements, driers to correct the moisture content of the substrate, sheeters in the event a cut sheet application is required or such other devices as may be necessary to complete the manufacture of the product of the present invention.

The release coating added is applied to the substrate in a thickness ranging from about 0.001 mils to 7 mils with about 0.01 to 3 mils being preferred.

The release coating may be applied throughout the entire area of the substrate so as to create a completely coated sheet or a substantially coated sheet or the coating may only appear or be applied in predetermined or selected areas of the substrate.

The coating may be applied through the use of fountains, meyer rods, curtains, sprays, vapor deposition, anilox rollers, gravure, reverse gravure, flexographic, printers (laser, ink jet, electrostatic, etc.) and such other means as are known and suitable for use in applying coatings.

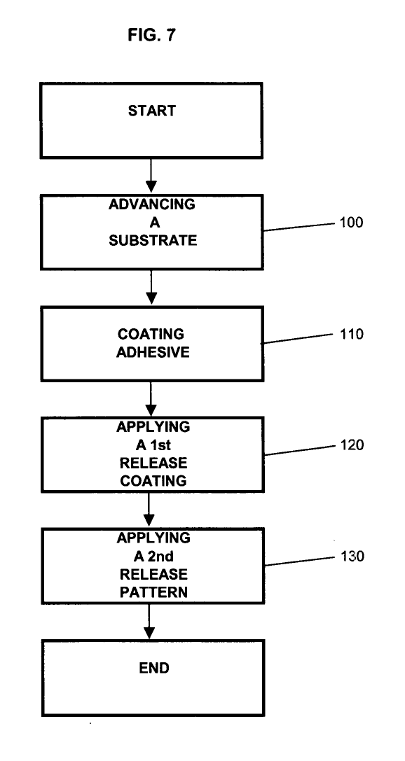

FIG. 7 provides a block diagram showing an exemplary method of practicing the present invention. Initially, a substrate is advanced at step 100. A pressure sensitive adhesive is applied at step 110 by coating the adhesive directly on to the substrate or web of material. Next, a first release coating, containing a substantial starch component is coated directly to the web or substrate at step 120. A second release coating may be applied to the web or substrate at step 130.

The application of two different release coatings, for example one having a starch component comprising less than 50% by weight and one having a starch component of greater than 50% can create different areas of textural distinction or characteristics so that a message, graphic, image, indicia or similar symbols or shapes can be provided directly on to the substrate or web. The designs, graphics, indicia that may be applied to the web of material in a continuous application or to separate sheets in a cut sheet arrangement may vary from sheet to sheet or label to label so as to create some variability with respect to the labels being provided to an end user. For example, if the linerless labels were for a pediatric application, the labels could be provided with a raised or tactilely distinct representation of animals, faces or any other suitable indicia.

It will thus be seen according to the present invention a highly advantageous linerless label having a starch based release coating has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadcast interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A linerless label comprising;
a substrate, said substrate having first and second side edges and first and second ends and first and second faces;
a pressure sensitive adhesive applied in a pattern to at least a portion of said first face; and
a starch, starch ester or combinations thereof based release coating applied in a pattern to at least a portion of said second face.

2. A linerless label as recited in claim 1, wherein said release pattern is substantially equal to said pattern of said pressure sensitive adhesive.

3. A linerless label as recited in claim 1, wherein said release pattern is greater than said pattern of said pressure sensitive adhesive.

4. A linerless label as recited in claim 1, wherein said release pattern includes at least one textural characteristic.

5. A linerless label as recited in claim 1, wherein said starch or starch ester based coating is derived from a group including corn, potato, wheat, rice, tapioca, maize, sorghum and other starches and starch flours and combinations thereof.

6. A linerless label as recited in claim 1, wherein a series of labels are provided in a continuous format.

7. A linerless label as recited in claim 6, wherein each of said labels in said series has a distinct textural attribute.

8. A linerless label as recited in claim 1, wherein said starch or starch ester ranges from about 0.01% to about 99.9% by weight of said release coating.

9. A linerless label as recited in claim 1, wherein said starch or starch ester has between about 2 to about 100 carbon atoms.

10. A linerless label as recited in claim 1, wherein said release coating creates a frangible coating area such that elements may be separated by cracking and bending.

11. A linerless label, comprising;
a substrate having first and second sides, first and second ends and top and bottom faces;
a pressure sensitive adhesive applied to said first side;
a release coating having a starch, starch ester or combinations thereof based component applied to said second side, said release coating having first and second patterns; and
said first pattern of said release coating applied substantially over said second face and said second pattern of release coating applied to predetermined portions of said second face to create texturally distinct areas.

12. A linerless label as recited in claim 11, wherein said predetermined portions are used to create graphics, images, symbols, shapes and combinations thereof.

13. A linerless label as recited in claim 11, wherein said second pattern of said release coating is applied in an area less than an area of said first pattern of said release coating.

14. A linerless label as recited in claim 11, wherein at least said first pattern of said release coating is applied in an area equal to said pressure sensitive adhesive, when said first face of said linerless label is brought into contact with a second face of another linerless label.

15. A linerless label as recited in claim 11, wherein said starch or starch ester based coating is derived from a group including corn, potato, wheat, rice, tapioca, maize, sorghum and other starches and starch flours and combinations thereof.

16. A linerless label as recited in claim 11, wherein a series of linerless labels may be provided in a continuous format.

17. A linerless label as recited in claim 16, wherein each of said series of linerless labels may have a distinct textural characteristic.

18. A linerless label as recited in claim 11, wherein said release coating creates a frangible coating such that elements may be separated from the label by cracking and bending.

19. A method of producing a linerless label comprising the steps of;
advancing a substrate having first and second faces;
coating on the first face of said substrate a pattern of pressure sensitive adhesive; and
applying at least a first pattern of release coating containing starch, a starch ester or combinations thereof to the second face of substrate such that said pattern of release coating is at least equal to said pattern of pressure sensitive adhesive.

20. A method as recited in claim 19, wherein a second pattern of release coating is applied after the step of applying the first pattern of release.

21. A method as recited in claim 20, wherein said second pattern of release coating is texturally distinct from said first pattern of release coating.

22. A method as recited in claim 20, wherein said first and second patterns of said release coating are applied substantially simultaneously.

23. A method as recited in claim 21, wherein said second pattern is used to create a texturally distinct image, graphic, figure, shape, indicia or combinations thereof.

24. A method as recited in claim 19, wherein an amount of said starch, starch ester or combinations thereof in said first pattern or release coating ranges from about 0.01% to about 99.9% by weight of said release coating.

25. A method as recited in claim 20, wherein said second pattern of release coating includes an amount of starch, starch ester or combinations thereof in ranging from about 0.01% to about 99.9% by weight of said second pattern of said release coating.

26. A linerless label, comprising;
a substrate having top and bottom faces;
a pattern of adhesive applied to the bottom face of the substrate; and
a discontinuous release coating applied to the top surface of the substrate and at least equal to an area covered by the pattern of adhesive, wherein said discontinuous coating contains a starch, starch ester component or a combination thereof.
